(19) United States
(12) Patent Application Publication
(10) Pub. No.: US 2026/0243352 A1
(43) Pub. Date: Aug. 20, 2026

(54) AUTOMATIC SHUT OFF VALVE

(71) Applicant: Enerco Group, Inc., Cleveland, OH (US)

(72) Inventors: Peter Baszuk, Richfield, OH (US); Nickolas Quinn, North Ridgeville, OH (US)

(73) Assignee: Enerco Group, Inc., Cleveland, OH (US)

(21) Appl. No.: 19/539,984

(22) Filed: Feb. 13, 2026

Related U.S. Application Data
(60) Provisional application No. 63/759,306, filed on Feb. 17, 2025.

(51) Int. Cl. F16K 1/36; F16K 3/312; F16K 11/044; F16K 15/06; F16K 15/18

(52) U.S. Cl. CPC F16K 1/36; F16K 3/312; F16K 11/044; F16K 15/063; F16K 15/1825

(57) ABSTRACT

One or more techniques and/or apparatuses are disclosed to provide for a main valve assembly that can be attached to a pressure tank, such as a propane tank. The main valve assembly can include a first, second, and third valve assembly. The first valve assembly can operate as a pressure relief valve that releases tank contents into atmosphere when a predetermined internal tank pressure is reached. The second valve assembly can also be used to fill/refill contents into the tank, and can be used for dispensing contents out of the tank, such as to an attached device through a fluid flow line. The third valve assembly has a shut off mechanism that allows fluid flow to vent from the tank during filling, and mitigates fluid flow to the vent when product in the tank reaches a predetermined shutoff level.

### CROSS-REFERENCE TO RELATED APPLICATIONS

This application claims priority to U.S. patent application no. 63/759,306, entitled AUTOMATIC SHUT OFF VALVE, filed Feb. 17, 2025, which is incorporated herein by reference.

### BACKGROUND

Compressed gas is stored in containers for use in various industries, such as carbon-based fuels used to power various devices such as heaters, grills, generators, smokers, and the like. These compressed gasses are often stored in, sold in, and dispensed from pressure tanks of various sizes. For example, common sizes of commercial-grade propane tanks are one pound, five pound, twenty pound, and forty pound. One pound propane tanks are typically single use tanks that are thrown away or recycled after their use. Because one pound tanks are smaller and more light-weight than most other propane tank sizes, they are popular for traveling, camping, hiking, and other outdoor recreational activities.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems are provided herein for a valve system that can be installed on a pressure tank and used for refilling, use, and reuse of pressurized fluid tanks, such as small one-pound propane tanks. Such a valve can be used for filling and refilling a tank, for pressure relief, and for the output of fluid (gas and/or liquid) in the tank. That is, for example, the valve system may be single unit a valve assembly that comprises separate valve components for performing various functions. As such, the valve assembly can comprise a pressure relief valve, an output system, and a gas/liquid filling and refilling system. Further, the valve system has an automatic shut off mechanism used during filling and/or refilling. That is, at a pre-determined fill point for the attached tank, the automatic shut off can seal the valve to prevent further filling of the tank.

In one implementation, a valve assembly for use on a pressure tank, such as a propane tank, can comprise main valve body configured to selectively engage with a pressure tank at a proximal end, and to selectively engage with a gas coupling line at a distal end. A first valve assembly can comprise a first valve sealing surface disposed in the main valve body and a valve seat disposed on a valve pin, wherein the valve seat is normally in direct contact with the first valve sealing surface. The first valve assembly can further comprise a first biasing component disposed in the main valve body that is engaged with the valve pin to normally bias the valve pin toward the proximal end of the main valve body, wherein the first biasing component comprises a biasing force equivalent to a predetermined high pressure for a tank engaged with the main valve body, Additionally, the first valve assembly can comprise a first vent that fluidly couples a proximal end of the main valve body with an environment external to the main valve body when the first valve seat is not engaged with the valve sealing surface.

A second valve assembly can be disposed in the main valve body. The second valve assembly can comprise a fluid control valve normally disposed in a closed position, wherein the fluid control valve is merely disposed in an open position when a fluid control valve pin is depressed into the fluid control valve. The second valve assembly can comprise a fluid flow passage in which the fluid control valve is disposed, wherein the fluid flow passage is fluidly couples an interior of the engaged tank with an exterior of the main valve body when the fluid control valve is disposed in the open position. Further, product can be dispensed through the second valve assembly into the engaged tank when the fluid control valve is disposed in the open position. Additionally, product can be dispensed out to the engaged tank through the second valve assembly when the fluid control valve is disposed in the open position.

A third valve assembly is disposed in the main valve body. The third valve assembly comprises a third valve sealing surface disposed in the main valve body and a valve gasket disposed on a valve pin, wherein the valve gasket is normally in direct contact with the third valve sealing surface. The third valve assembly also comprises a third valve biasing component disposed in the main valve body that is engaged with the valve pin to normally bias the valve pin toward the distal end of the main valve body. Further, a third valve vent fluidly couples a proximal end of the main valve body with an environment external to the main valve body when the third valve seat is not engaged with the valve gasket. Additionally, a shutoff mechanism is operably disposed inside the engaged tank, and the shutoff mechanism is fluidly engaged with the vent via a vent tube, wherein the shutoff mechanism is configured to mitigate flow of fluid through the vent tube when product inside the engaged tank reaches a predetermined shutoff level.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1 is a component diagram illustrating one example of a use for a valve assembly described herein.

FIGS. 2A and 2B are component diagrams illustrating an exemplary implementation of a system for refilling a propane tank as described herein, such as for a pressure relief valve assembly.

FIGS. 3A and 3B are component diagrams illustrating an exemplary implementation of a system for filling/refilling a propane tank as described herein, such as for the evacuation of tank contents.

FIGS. 4A and 4B are component diagrams illustrating an exemplary implementation of a system for refilling a propane tank as described herein, such as for using product in an engaged tank.

FIGS. 5A and 5B are component diagrams illustrating an exemplary implementation of a system for refilling a propane tank as described herein, such as for evacuating product from the tank.

FIGS. 6A, 6B and 6C are component diagrams illustrating an exemplary implementation of a system for refilling a propane tank as described herein, such as using a shut off mechanism.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

One-pound propane tanks are commonly used for portable appliances, such as heaters, cookers, lamps, and more; often used outdoor recreation such as camping, hiking, fishing, or the like. The one-pound tanks are popular for such uses because they are smaller, lighter, and more compact than typical twenty-pound propane tanks. These styles of propane tanks are made to be disposable, typically single use tanks that are thrown away or recycled after every use. This may create excess waste, may not be environmentally friendly, may cost more to manufacture, and may be expensive to purchase from a consumer standpoint. A refillable propane tank system may mitigate cost, reduce tank manufacturing, reduce waste, and may reduce negative environmental effects by allowing consumers to refill their tanks rather than throwing them away. One will readily appreciate the benefits of such a system compared to the single use tanks that are commercially available.

Provided herein is a valve assembly system and method of use for the use and refilling of a pressurized fuel tank such as a propane tank or the like, and can serve as the pressure relief valve, and an automatic shut off valve during filling. By way of an example implementation, the valve assembly system and method may be provided to use and to refill a one-pound propane tank with propane from a twenty-pound (or other) propane tank (e.g., or other fuels). However, it is anticipated that other pressure tanks that hold pressurized gases, liquids or the like, may also utilize the disclosed valve assembly system and method.

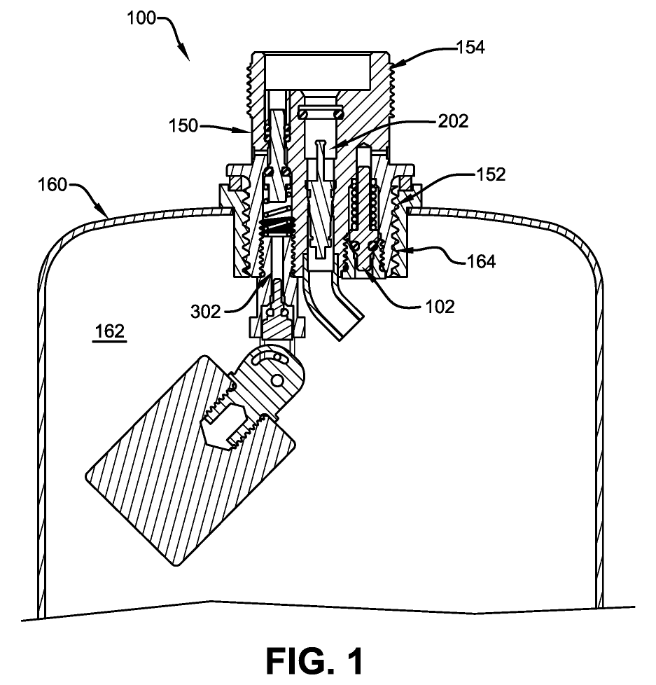

FIG. 1 is a component diagram illustrating an example implementation of such a valve assembly system 100. In this example, the valve assembly system 100 comprises a body 150 that is configured to operably engage with a pressure tank 160, that comprises an interior 162 configured to hold a pressurized fluid (e.g., liquid propane). As illustrated, in this example, the body 150 of the valve assembly system 100 comprises threads 152 (e.g., internal threads) at its proximal end that can engage with complementary tank threads 164 (e.g., external threads) to selectively, fixedly engage the valve assembly system 100 with the tank 160. Further, the body 150 of the valve assembly system 100 comprises threads 154 (e.g., external threads) at its distal end that can engage with complementary fluid fill line threads (not shown; e.g., external threads) to selectively, fixedly engage the valve assembly system 100 with the fluid transfer line (not shown). In this implementation, the valve assembly system 100 comprises a first valve assembly 102 (a pressure relief valve assembly), a second valve assembly 202 (e.g., evacuating, filling, dispensing valve assembly), and a third valve assembly 302 (e.g., and automatic shut off valve assembly). Each of which is described further below. Of note, when describing a proximal or distal end or potion, proximal relates to the end, area, or portion closest to the part that connects with a pressure tank; and distal relates to the end, area, or portion closest to the part that connects with the fluid line, such as a hose for use or for filling/refilling.

### Pressure Relief Valve System:

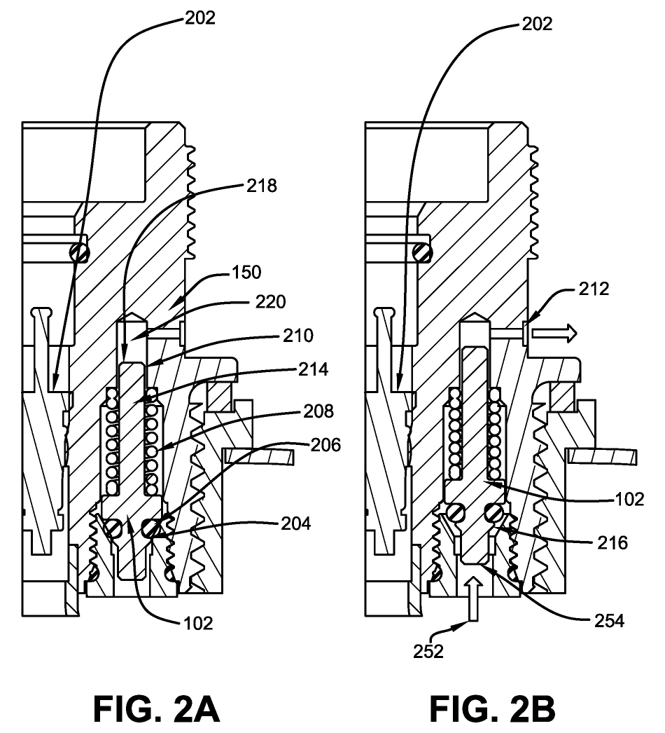

A pressure relief valve assembly (first valve assembly 102, also described as the first valve in this specification) can be incorporated into a body of a main valve assembly system. The pressure relief valve can be configured to relieve pressure in the event of an overpressure condition inside an attached tank onto which the valve assembly is installed. As illustrated in FIGS. 2A and 2B, with continued reference to FIG. 1, the pressure relief valve assembly 102 (e.g., first valve assembly) disposed in the body 150 of the main valve assembly system 100, can be comprised of a pressure relief valve pin 214 (first valve pin), sealing surface 204, a mating gasket 206, a biasing member 208 (e.g., pressure spring calibrated to a predetermined pressure), a guide system 210, and a vent 212.

During normal operation, and shown in FIG. 2A, the pressure relief valve assembly 102 is configured to remain in a closed and sealed (a first) position. As an example, if the internal pressure of the tank on which the main valve assembly system 100 is installed exceeds a predetermined threshold, the biasing force of the biasing member 208 will be overcome, and the valve will open, as shown in FIG. 2B. As illustrated, pressure 252 is exerted on a proximal end 254 of the pressure relief valve pin 214. In turn, if the pressure 252 exerted overcomes a biasing force applied by the biasing member 208 to the pin 214, a pin sealing seat 216 and the mating gasket 206 are forced away from the sealing surface 204, thereby opening a passage between the interior of the tank (not shown) and the vent 212. In this example, a distal portion 218 of the pin is an elongated stem portion of the guide system 210, which is guided along a guide passage 220 of the guide system 210. In this example, the open pressure relief valve assembly 102 will relieve the tank of excess pressure by venting to the outside.

Further, once the internal pressure of the tank drops below the predetermined high limit threshold, and the internal pressure no longer overcomes the biasing force of the biasing member 208, the pressure relief valve can reseal and return to the closed and sealed position. In this example, the pin sealing seat the pin 216 and the mating gasket 206 are in contact with the sealing surface 204 of the pressure relief valve assembly 102.

### Fluid Filling/ Refilling System:

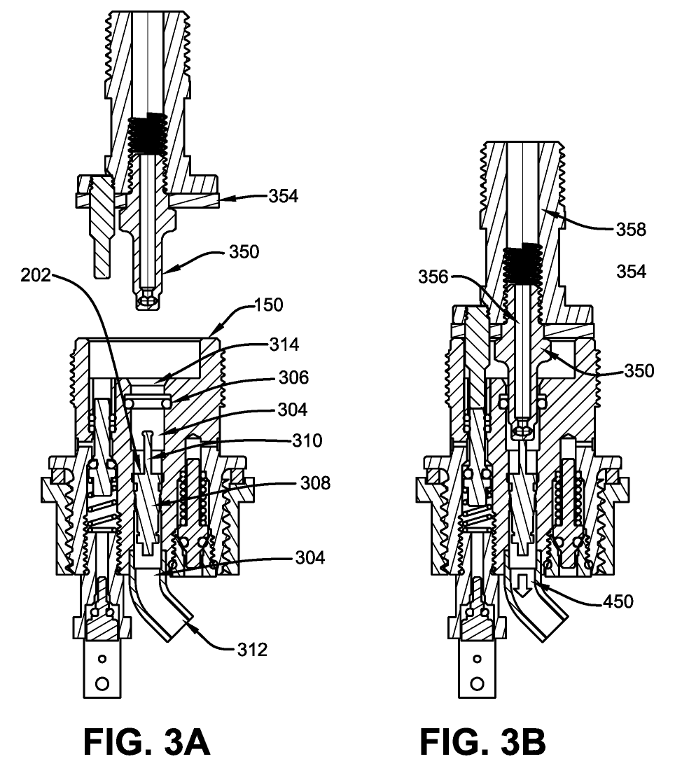

As illustrated in FIGS. 3A and 3B, with continued reference to FIG. 1, the second valve assembly 202 (also known as the fill/refill valve assembly or fill valve or second valve) is incorporated into the body 150 of the main valve assembly system 100. The second valve assembly 202 is configured to provide multiple functions. In one implementation, the second valve assembly 202 can be used for the filling and/or refilling process of an attached tank. In this implementation, the second valve assembly 202 incorporated into the body 150 of the main valve system assembly 100, can also be configured to accommodate the filling and/or refilling of contents into the tank. In this implementation, a fluid control valve 308 is normally biased in a closed and sealed state, as illustrated in FIGS. 3A.

As shown in FIG. 3A, the second valve assembly 202 is normally in a closed condition at least until engaged by a mating first probe 350. The second valve assembly 202 comprises a valve fluid passage 304, a first probe sealing gasket 306 in the passage 304, and a fluid control valve 308. The fluid control valve 308 comprises an activator pin 310 (or second valve pin) at its distal portion. When the activator pin 310 is depressed, such as by an attached complementary pin or member of a fluid flow line (not shown, aka fluid coupling line), as shown in FIG. 3B, the valve fluid passage 304 is open between a proximal end 312 and a distal end 314, thereby allowing fluid flow through the valve fluid passage 304. When the activator pin 310 is in its normal or biased position, as in FIG. 3A, the valve fluid passage 304 is closed between the proximal end 312 and a distal end 314, thereby mitigating flow of fluid through the valve fluid passage 304.

As shown in FIG. 3A, the fluid control valve 308 is opened using the first probe 350, such as when a coupling 354 of a fluid flow line is engaged with the body 150 of the main valve system assembly 100. In this implementation, the coupling 354 is fluidly coupled with a hose 358 (fluid flow line) through an internal passage 356. The coupling 354 can be designed for dispensing the target product into the tank 160; that is, an appropriate propane coupling 354 and hose 358 can be used for a propane tank 160. In some implementations, the fluid control valve 308 can be configured to accommodate a specific, desired transfer rate of the product into the tank. Further, in some implementations, sealing components within the fluid control valve 308 can be configured to withstand temperatures associated with the target product, such as liquid propane. As an example, the target product 450 can be transferred through the first probe 350, through the valve fluid passage 304 via the open fluid control valve 308, and into the tank’s interior 162, as shown in FIG. 3B. In this example, when the filling/refilling coupling 354 and first probe 350 are removed, the fluid control valve 308 self-closes and seals the contents in the tank 160, as shown in FIG. 3A.

### Fluid Output System:

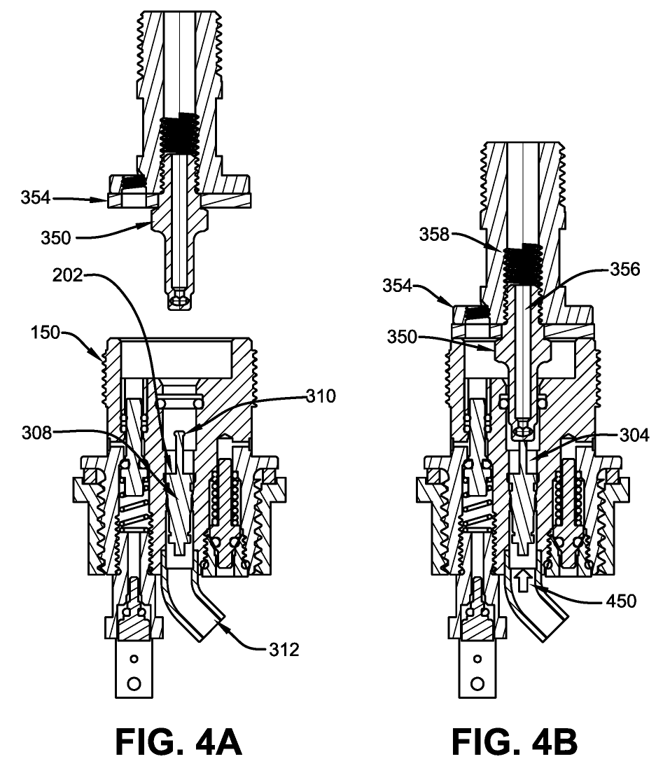

FIGS. 4A and 4B illustrate an example of the second valve assembly 202 during use, such as dispensing of the product 450 out from the tank 160 (e.g., propane used for a heater). In this implementation, the second valve assembly 202 incorporated into the body 150 of the main valve system assembly 100, can also be configured to enable the flow of the tank’s contents to a connected device or system. Again, in its normal state, as illustrated in FIG. 4A, the fluid control valve 308 is closed and prevents the flow of product out of the connected tank interior 162. When the valve 308 is activated by the first probe 350 of the coupling 354, as shown in FIG. 4B, such as from a connected device, the first probe 350 depresses the activator pin 310, which opens the fluid control valve 308, thereby allowing fluid 450 (e.g., propane or other pressurized fuel or fluid) to flow through the valve fluid passage 304. In this way, for example, the product 450 can flow from the tank, through the coupling 354, to the connected device. As an example, the fluid flow of propane will continue until the tank is emptied of its contents, or the second valve assembly 202 is closed, such as by removing the coupling 354. When the second valve assembly 202 is closed, the tank will return to a sealed state, as shown in FIG. 4A.

### Tank Venting for Subsequent Filling/Refilling:

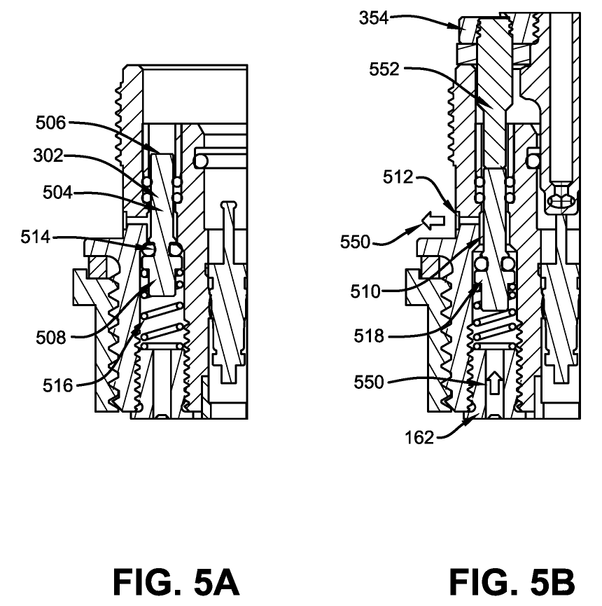

As illustrated in FIGS. 5A and 5B, with continued reference to FIGS. 1, 3A, and 3B, the third valve assembly 302 (also known as the third valve) is incorporated into the body 150 of the main valve assembly system 100. The third valve assembly 302 is configured to provide myriad functions. In one implementation, the third valve assembly 302 can be used to enable the contents 550 of the tank 160 to be evacuated from the interior 162. As one example, systems for filling and/or refilling a tank may provide a predetermined amount (e.g., mass and/or volume) of gas/liquid to the tank during filling/refilling. In this example, if some gas/liquid 550 remains in the tank 160 at the time of a filling/refilling process, the introduction of a predetermined or preset amount of product 550 could result in an overfilling of the tank 160, and/or a potentially a release of the product 550 into the surrounding atmosphere, due to the preexisting product in the tank. As such, in these examples, during the initial filling and refilling processes, product that remains inside the tank 162, along with internal pressure, can be removed from the tank 160 prior to filling with the predetermined amount of product 550.

As shown in FIG. 5A, the third valve assembly 302 remains in a closed condition at least until engaged by a mating second probe 552. That is, in this implementation, the coupling 354 comprises a second probe 552 that is configured to engage with the third valve assembly 302 when the coupling 354 is engaged with the body 150 of the main valve assembly system 100. In this implementation, the third valve assembly 302 comprises a third valve pin 504 with an elongate distal portion 506 and a proximal portion 508. A third valve fluid passage 510 allows fluid (e.g., gas) to flow from the interior of the tank 162 to a vent 512.

The third valve fluid passage 510 is sealed in the normal position, as illustrated in FIG. 5A, using a second probe sealing gasket 514 in the passage 510. When the elongate portion 506 is depressed by the second probe 552, as shown in FIG. 5B, the third valve fluid passage 510 is open between the interior of the tank 162 and the vent 512, to vent product 550 from the vent 512. In this way, for example, the tank 160 may be prepared for filling/refilling with a predetermined amount of fluid (e.g., one-pound of propane). When the third valve fluid passage 510 is in its normal or biased position, as in FIG. 3A, the third valve fluid passage 510 is closed between the proximal end 508 and a vent 512, thereby mitigating flow of fluid (e.g., gas) through the third valve fluid passage 510.

When a second probe 552 is engaged, the third valve pin 504 is depressed and the third valve assembly 302 will open allowing for the contents 550 (e.g., gas//liquid) to be evacuated from the tank 160 through the third valve fluid passage 510. In this example, as shown in FIG. 5B, the coupling 354 with the second probe 552 engages the third valve pin 504. In this implementation, a biasing force applied by a biasing member 516 holds a sealing gasket 514 against a third valve sealing surface 518 to close the valve fluid passage 510. When the second probe 552 is applied to the third valve pin 504, the biasing force is overcome, moving the sealing gasket 514 away from the third valve sealing surface 518, to open the valve fluid passage 510. Because the third valve assembly 302 is open, fluid (e.g., gas) flow is allowed through the valve fluid passage 510 to the vent 512, and the contents 550 can be evacuated from the interior of the tank 162 to the vent 512. In some implementations, a collection means, such as a pipe, tube, or line, can be coupled to the vent 512 to collect the evacuated product 550. In some implementations, once the contents are vented, the tank 160 will be ready for the next process, such as filling/refilling.

### Automatic Shutoff for Filling/ Refilling:

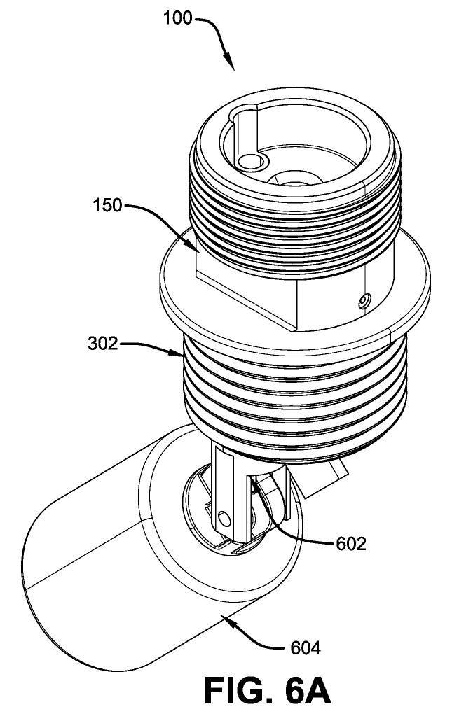

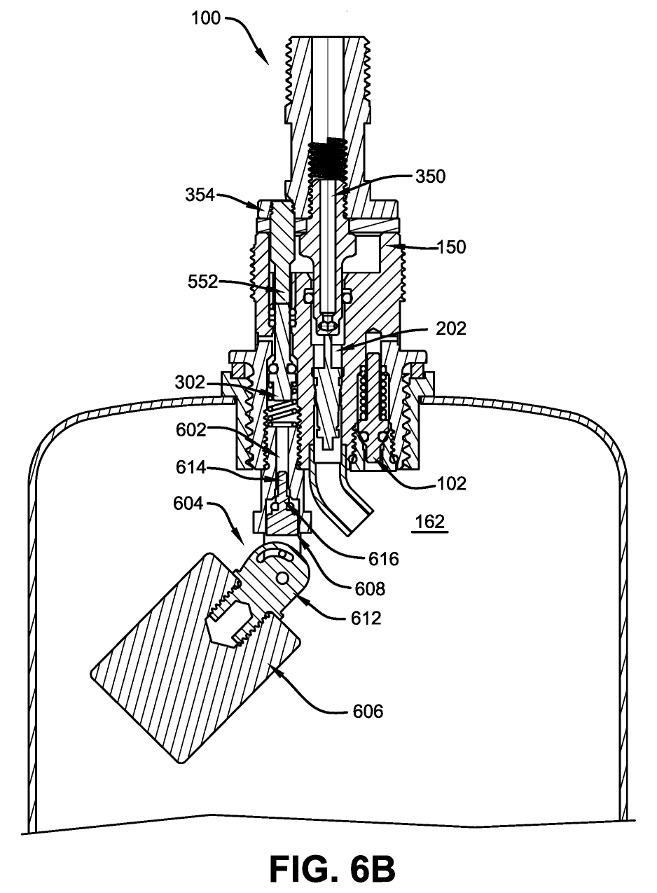

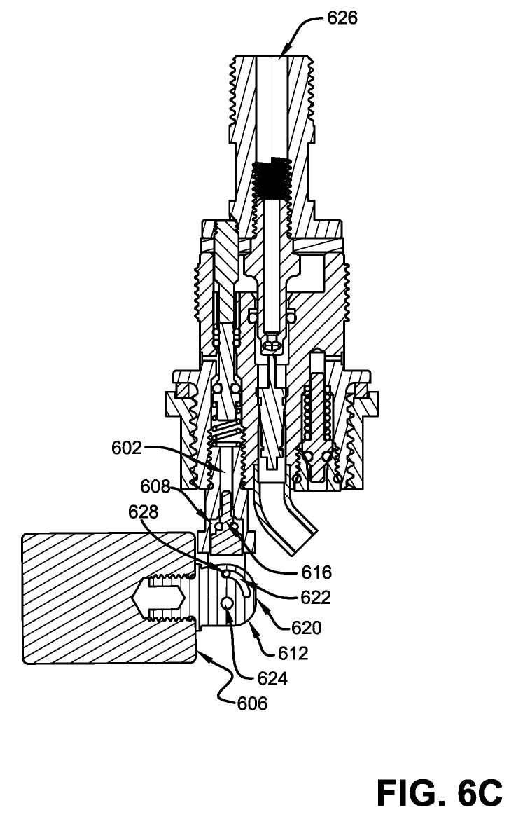

FIGS. 6A, 6B, and 6C illustrate portions of the third valve assembly 302, as applied to the main valve assembly 100. In this implementation, the third valve assembly 302 comprises a vent tube 602, that is fluidly coupled with the third valve fluid passage 510. Further, a shutoff mechanism 604 is attached to the vent tube 602, which is operably disposed in the interior 162 of the attached tank 160. The shutoff mechanism 604 comprises a float 606 that is configured to float on top of the target product inside the tank 160. As the float 606 is activated (e.g., rises) the shutoff mechanism 604 is configured to close an intake passage 608 into the vent tube 602. Activation of the float 606 occurs when product inside the tank 162 reaches the level of the float 606 (e.g., a predetermined shutoff level that is calibrated to meet a predetermined amount of the target fluid/product), and continues to rise, thereby lifting the float 606 and rotating a cam assembly 612. The cam assembly 612 is coupled to a float pin 614 or float valve that is normally disposed in an open position in the intake passage 608 when the float is not activated (e.g., downward, such as not floating on the product), as illustrated in FIG. 6A and 6B. As illustrated in FIG. 6B, the float 606 is disposed in the tank 162, and the float 606 will rise as the tank 162 is filled with product. The float 606 will continue to rise and be activated when it meets a predetermined position the intake passage 608, as in FIG. 6C. At the predetermined position, the cam operably disposed the float pin 614 in a closed position, and seals that opening, as in FIG. 6C. Further, during filling/refilling, air (or other gases) can exit through the open vent 512, at least until the intake passage 608 is sealed by the shutoff mechanism 604, thereby stopping further venting of gas.

For example, when the shutoff mechanism 604 seals the intake passage 608, product internal to the tank 162, and pressure (and gas), is mitigated from venting to the outside. As an example, if propane is being filled into the tank 160, the level of liquid propane rises during the filling/refilling process, and the buoyant float 606, having a buoyancy configured to float on the target product) in the shutoff mechanism 604 also rises. At the predetermined shutoff level, a seal 616 on the float pin 614 engages a seat in the opening in the intake passage 608 on the vent tube 602 and seals that fluid passage. By sealing the vent tube 602, the pressure in the tank can substantially equalize with the pressure from the filling tool attached by the coupling 354. When the pressures are substantially equivalent, additional propane is mitigated from entering the tank, as such, the filling/refilling can be automatically shut off from further filling. For example, this level is set so that the liquid propane is at a level (e.g., comprising one-pound of propane) that still leaves open volume to allow the propane to expand as the ambient temperature of the cylinder rises.

The cam assembly 612 comprises an armature 620 that is engaged with a distal end of the float 606. The armatures 620 comprises a curved groove 622 (e.g., a cut out portion of the armature 620) disposed radially from a rotation point 624 of the float 606. The curved groove 622 has an arc aligned with the rotation of the float 606, at the rotation point 624 disposed on the proximal end of the float 606, which has an axis of rotation substantially perpendicular to a longitudinal axis 626 of the main body 150. The curved groove 622 is slidably engaged with a mount 628 (such as a pin or raised portion) disposed on the float pin 614. In this way, for example, when the float 606 rises from a downward toward a perpendicular position, the armature 620 rotates around the axis of rotation of the float, at the rotation point 624. This results in rotation of the curved groove 622, which results in the mount 628 translating toward the distal direction. Translation of the mount 624, which is engaged with the float pin 614, moves the float pin in the distal direction, thereby seating the seal 616 against the seat in the opening of the intake passage 608. In this example, the raising of the float to the predetermined level results in the opening of the intake passage 608 being sealed from fluid exiting through the vent tube 602 to the third valve assembly 302.

It should be noted that the shape and design of the cam assembly, including the armature, groove, pivot point, etc., can be reconfigured to accommodate different sized and shaped tanks, and different target products. That is, a tank that is of a different size, shape or configuration may have a need for differently sized armatures, groove lengths and arcs, different positions of the pivot point, and different couplings between the armature and float pin. Different products that have different densities may necessitate differently shaped floats. The concept described herein is not limited to the example designs, but merely an illustrative example to show the relationships between the various assemblies that are configured to shut the valve or opening between the inside of the tank and the outside when a filling operation has introduced a desired amount of product into the tank. It is anticipated that alternative assemblies may be envisioned to accomplish substantially the same results.

In some implementations, the density of the float 606 is 0.33 g/cm³ with a total surface area of 29.3 cm². The float 606 may maintain 16.3 cm² surface area wetted. As the liquid level rises, the float 606 angle and the specific area that is wetted may change, but the surface area wetted will not change. In some implementations, the buoyant force on the float 606 may be only 3.96 grams of force, but the force greatly increases to 109.6 grams of force on the pin once the float is submerged and the liquid level rises due to the float acting on the end of an arm of the cam system 612. The pin pushing up into position with the pressure of the propane vapor trying to escape and pushing on the surface of the O-ring creates the largest amount of sealing force. In some implementations, the specific gravity of propane is .5079, based on DOT and NFPA requirements. It should be noted that this description is merely an example, and that float density, surface area, shape and size can be adjusted to accommodate different sized tanks, different target products, different tank configurations, and other systems. The concept reduced to practice, described herein, is the use of the float system, configured to the target product, to close the intake passage such that the filling process may be appropriately ended. The shape, size, density, etc. of the float with regard to the target product is expected to be adjusted based on the target product (density), predetermined amount of product, size, shape and configuration of the tank, and the type of target product. That is, the float and valve system may be adjusted according to its target use.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A pressurized gas or liquid valve assembly system comprising:
a main valve body configured to selectively engage with a pressure tank at a proximal end, and to selectively engage with a coupling of a fluid flow line at a distal end;
a first valve assembly disposed in the main valve body configured to provide for pressure relief from a tank engaged with the main valve body merely at a predetermined pressure level in the engaged tank;
a second valve assembly disposed in the main valve body comprising a fluid flow passage between the proximal and distal ends of the main valve body, and a fluid control valve normally closed toward the distal end that is configured to open when engaged with a coupling of the fluid flow line; and
a third valve assembly disposed in the main valve body, the third valve assembly comprising a third valve vent fluidly coupling a proximal end of the main valve body with an environment external to the main valve body when a third valve pin is not seated in a third valve sealing surface, wherein the third valve pin is normally disposed toward the proximal end of the main valve body; and
a shutoff mechanism operably disposed inside the engaged tank, the shutoff mechanism fluidly coupled with the third valve vent by a vent tube, wherein the shutoff mechanism is configured to mitigate flow of fluid through the vent tube when product inside the engaged tank reaches a predetermined shutoff level.

2. The valve assembly system of claim 1, wherein the first valve assembly comprises a first valve vent passage fluidly coupling the proximal end of the main valve body with the distal end of the main valve body, the first valve assembly normally biased closed toward the proximal end.

3. The valve assembly system of claim 1, wherein the first valve assembly comprises:
a first valve sealing surface disposed in the main valve body and a first valve seat disposed on a first valve pin, wherein the first valve seat is normally in direct contact with the first valve sealing surface;
a first valve biasing component disposed in the main valve body that is engaged with the first valve pin to normally bias the valve pin toward the proximal end of the main valve body, wherein the first valve biasing component comprises a biasing force substantially equivalent to the predetermined pressure level for the pressure tank engaged with the main valve body; and
a first valve vent that fluidly couples the proximal end of the main valve body with an environment external to the main valve body when the first valve seat is not engaged with the first valve sealing surface.

4. The valve assembly system of claim 1, wherein the second valve assembly comprises:
a second fluid control valve pin, wherein the fluid control valve is merely disposed in an open position when the second fluid control valve pin is depressed into the fluid control valve;
wherein the fluid flow passage fluidly couples an interior of the engaged tank with an exterior of the main valve body when the fluid control valve is disposed in the open position;
wherein the second valve assembly is configured to allow product to be introduced through the fluid flow passage into the engaged tank when the fluid control valve is disposed in the open position, and for product to be dispensed out to the engaged tank through the second valve assembly when the fluid control valve is disposed in the open position.

5. The assembly system of claim 1, wherein the third valve assembly comprises:
a third valve sealing surface disposed in the main valve body, wherein the third valve pin is normally contacts the third valve sealing surface in the distal direction;
a third valve biasing component disposed in the main valve body that is engaged with the third valve pin to normally bias the third valve pin toward the distal end of the main valve body;
a third valve vent that fluidly couples a proximal end of the main valve body with an environment external to the main valve body when the third valve seat is not engaged with the third valve pin.

6. The valve assembly system of claim 5, further comprising a third valve gasket disposed at the distal end of the third valve pin, the third valve gasket operably, normally seated against the third valve sealing surface.

7. The valve assembly system of claim 1, wherein the shutoff mechanism comprises a float that is configured to operably float on a target product in the tank and to close an intake passage to the vent tube when the float reaches the predetermined shutoff level.

8. The valve assembly system of claim 7, wherein the shutoff mechanism further comprises a cam assembly engaged with a distal end of the float, the cam assembly configured to operably close a float pin to a sealed position when the float reaches the predetermined shutoff level.

9. The valve assembly system of claim 8, wherein the cam assembly comprises an armature having a curved groove with an arc that curves in a direction of rotation of the cam assembly, and is engaged with a mount disposed on the float pin, such that when the armature rotates with a rotation of the float around a point of rotation of the float, the mount slides along the curved groove resulting in the float pin translating toward the distal direction.

10. The valve assembly system of claim 8, wherein the shut of assembly further comprises a seal disposed on the float pin that operably engages with an opening in an intake passage to the float tube.

11. The valve assembly system of claim 1, wherein the main valve body further comprises first threads configured to threadedly engage with complementary tank threads of the tank to selectively, fixedly engage the tank with the valve assembly system.

12. The valve assembly system of claim 1, wherein the main valve body further comprises second threads configured to threadedly engage with complementary fluid line coupling threads of the fluid flow line to selectively, fixedly engage the fluid flow line with the valve assembly system.

13. The valve assembly system of claim 1, further comprising a fluid line coupling configured to engage with the main valve body and fluidly couple to the engaged tank through a the fluid flow line, wherein the coupling comprises a first and second probe.

14. The valve assembly system of claim 13, wherein the first probe is configured to, when the fluid line coupling is engaged with the main valve body, engage and depress the fluid control valve thereby shifting the fluid control valve to an open position.

15. The valve assembly system of claim 13, wherein the second probe is configured to, when the fluid line coupling is engaged with the main valve body, engage and depress the third valve pin to open fluid flow through the third valve vent.

16. A method for making a pressurized gas or liquid valve and tank assembly system for a pressure tank, comprising:
selectively engaging a main valve body of a valve assembly with a pressure tank, wherein the main valve body comprises:
a first valve assembly disposed in the main valve body configured to provide for pressure relief from a tank engaged with the main valve body merely at a predetermined pressure level in the engaged tank;
a second valve assembly disposed in the main valve body comprising a fluid flow passage between the proximal and distal ends of the main valve body, and a fluid control valve normally closed toward the distal end that is configured to open when engaged with a coupling of the fluid flow line; and
a third valve assembly disposed in the main valve body, the third valve assembly comprising a third valve vent fluidly coupling a proximal end of the main valve body with an environment external to the main valve body when a third valve pin is not seated in a third valve sealing surface, wherein the third valve pin is normally disposed toward the proximal end of the main valve body; and
engaging a shutoff mechanism with the third valve assembly, wherein the shutoff mechanism is disposed inside the engaged tank, and the shutoff mechanism is fluidly coupled with the third valve vent by a vent tube, wherein the shutoff mechanism is configured to mitigate flow of fluid through the vent tube when product inside the engaged tank reaches a predetermined shutoff level.

17. The method of claim 16, wherein selectively engaging a main valve body of a valve assembly with a pressure tank comprises engaging the main valve body of the valve assembly with a pressure tank such that the third valve assembly comprises:
a third valve sealing surface disposed in the main valve body, wherein the third valve pin is normally contacts the third valve sealing surface in the distal direction;
a third valve biasing component disposed in the main valve body that is engaged with the third valve pin to normally bias the third valve pin toward the distal end of the main valve body;
a third valve vent that fluidly couples a proximal end of the main valve body with an environment external to the main valve body when the third valve seat is not engaged with the third valve pin.

18. A pressurized gas or liquid valve assembly system engaged with a pressure tank comprising:
a main valve body selectively engage with the pressure tank at a proximal end, and configured to selectively engage with a coupling of a fluid flow line at a distal end;
a first valve assembly disposed in the main valve body configured to provide for pressure relief from a tank engaged with the main valve body merely at a predetermined pressure level in the engaged tank, the first valve assembly comprising a first valve vent passage fluidly coupling the proximal end of the main valve body with the distal end of the main valve body, the first valve assembly normally biased closed toward the proximal end;
a second valve assembly disposed in the main valve body comprising a fluid flow passage between the proximal and distal ends of the main valve body, and a fluid control valve normally closed toward the distal end that is configured to open when engaged with a coupling of the fluid flow line, the second valve assembly comprising:
a second fluid control valve pin, wherein the fluid control valve is merely disposed in an open position when the second fluid control valve pin is depressed into the fluid control valve;
wherein the fluid flow passage fluidly couples an interior of the engaged tank with an exterior of the main valve body when the fluid control valve is disposed in the open position;
wherein the second valve assembly is configured to allow product to be introduced through the fluid flow passage into the engaged tank when the fluid control valve is disposed in the open position, and for product to be dispensed out to the engaged tank through the second valve assembly when the fluid control valve is disposed in the open position;
a third valve assembly disposed in the main valve body, the third valve assembly comprising a third valve vent fluidly coupling a proximal end of the main valve body with an environment external to the main valve body when a third valve pin is not seated in a third valve sealing surface, wherein the third valve pin is normally disposed toward the proximal end of the main valve body, the third valve assembly comprising:
a third valve sealing surface disposed in the main valve body, wherein the third valve pin is normally contacts the third valve sealing surface in the distal direction;
a third valve biasing component disposed in the main valve body that is engaged with the third valve pin to normally bias the third valve pin toward the distal end of the main valve body;
a third valve vent that fluidly couples a proximal end of the main valve body with an environment external to the main valve body when the third valve seat is not engaged with the third valve pin; and
a shutoff mechanism operably disposed inside the engaged tank, the shutoff mechanism fluidly coupled with the third valve vent by a vent tube, wherein the shutoff mechanism is configured to mitigate flow of fluid through the vent tube when product inside the engaged tank reaches a predetermined shutoff level.

19. The valve assembly system of claim 18, wherein the shutoff mechanism comprises:
a float that is configured to operably float on a target product in the tank and to close an intake passage to the vent tube when the float reaches the predetermined shutoff level; and
comprises a cam assembly engaged with a distal end of the float, the cam assembly configured to operably close a float pin to a sealed position when the float reaches the predetermined shutoff level.
